(19) United States
(12) Patent Application Publication
(10) Pub. No.: US 2009/0279204 A1
(43) Pub. Date: Nov. 12, 2009

(54) Method and apparatus for flyng height on demand heaters in a hard disk drive

(76) Inventor: Eun Kyu Jang, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/152,454

(22) Filed: May 12, 2008

(51) Int. Cl. G11B 5/33; G11B 33/14

(52) U.S. Cl. 360/97.02; 360/313; 360/75

(57) ABSTRACT

A hard disk drive is disclosed with a slider containing a Flying height On Demand (FOD) heater using two heater sheets configured to be driven by electric currents flowing in essentially opposite directions, causing the magnetic field induced by the FOD heater to be much smaller than prior art FOD heaters using just one sheet with a single current direction. Also disclosed are the slider, the head gimbal assembly, and the head stack assembly, where both assemblies include at least one instance of the slider. Also disclosed, the methods of operating the hard disk drive and the slider and making the slider, the head gimbal assembly, the head stack assembly and the hard disk drive.

### TECHNICAL FIELD

This invention relates to thermal micro-actuators known herein as Flying height On Demand (FOD) heaters in sliders included in hard disk drives.

### BACKGROUND OF THE INVENTION

In the last few years, hard disk drives have appeared that include a thermal micro-actuator in their sliders that is often used to alter the flying height of the slider over a rotating disk surface. These micro-actuators heat a portion of the slider, which is then distorted by thermal expansion. Besides creating heat, the electric current through these micro-actuators also generates a magnetic field strong enough to adversely affect the magnetization of portions of the magnetic layers of the read head and/or the write head and the magnetic material in the rotating disk surface. Methods and apparatus are needed that reduce the leakage magnetic field of a thermal micro-actuator affecting the read-write head of the slider and/or the magnetic material of the rotating disk surface.

### SUMMARY OF THE INVENTION

Embodiments of the invention include a hard disk drive using a slider containing a Flying height On Demand (FOD) heater using two heater sheets configured to be driven by electric currents flowing in generally opposite directions, causing the magnetic field induced by the FOD heater to be much smaller than in prior art FOD heaters using just one sheet with a single current direction. Simulation analysis of the prior art FOD heater versus the invention's FOD heater showed a large reduction in field strength. This reduction positively affects the read head and the write head of the slider, and their interactions with data stored on a rotating disk surface they access, improving performance and increasing the reliability and longevity of the hard disk drive.

Embodiments of the invention include but are not limited to the apparatus of the slider, the head gimbal assembly, and the head stack assembly, where both assemblies include at least one instance of the slider. Embodiments of the invention also include but are not limited to the method of operation of the hard disk drive and the slider. Embodiments of the invention include methods of making the slider, head gimbal assembly, head stack assembly and/or the hard disk drive.

### BRIEF DESCRIPTION OF THE DRAWINGS

FIG. 1 shows an example of an embodiment of the invention as a hard disk drive including a disk base to which a spindle motor is mounted with at least one disk rotatably coupled to the spindle motor to create a rotating disk surface. A voice coil motor includes a head stack assembly pivotably mounted by an actuator pivot to the disk base, responsive to its voice coil interacting with a fixed magnetic assembly mounted on the disk base and configured to pivot at least one head gimbal assembly to position the invention's slider with its Flying height On Demand (FOD) heater near a track on the rotating disk surface.

FIG. 2A shows a perspective view of some details an example of the voice coil motor of FIG. 1 including the head stack assembly with the voice coil, the actuator pivot, the actuator arm, and more than one head gimbal assembly for a hard disk drive including more than one disk.

FIG. 2B shows a side view of an example of the head gimbal assembly of the previous Figures with an embodiment of the invention's slider including the FOD heater between the write head and the read head inducing a reduced magnetic field affecting the heads and the rotating disk surface.

FIG. 3 shows an example prior art FOD heater with a single heater sheet as a layer diagram of the slider as seen from the rotating disk surface with its F+ and F− contacts and single heater sheet having the current flowing in one direction inducing the prior art magnetic field much stronger than the reduced magnetic field of the invention's FOD heater as shown in FIG. 2B and in the following Figures.

FIG. 4A shows an example of an embodiment of invention's slider with its FOD heater including two heater sheets electrically coupled in series between the F+ and F− contacts as seen from the rotating disk surface.

FIG. 4B shows the FOD heater of FIG. 4A with the first current flowing through the first heater sheet is essentially opposite the second current flowing through the second heater sheet, effectively canceling each other magnetically to create the reduced magnetic field.

FIG. 5 shows an example of an embodiment of the invention's slider with its FOD heater including two heater sheets electrically configured in parallel between the F+ and F− contacts as seen from the rotating disk surface, where the parallel electrical couplings of these contacts to the first and second heater sheets is configured for the first current flowing through the first heater sheet to be essentially opposite the second current flowing through the second heater sheet, effectively canceling each other magnetically to create the reduced magnetic field.

FIG. 6A shows a front view of one example embodiment of the FOD heater of FIG. 4A, configured for the first current to flow through the first heater sheet to be essentially opposite the second current flowing through the second heater sheet, effectively canceling each other magnetically to create the reduced magnetic field. The bump or dent in the sheets increases the resistance in a region of the slider, which will tend to focus the heat generated by the FOD heater. These two heater sheets may be formed from a single layer of heater material through an etching process and do not involve the use of vias as shown in FIG. 4B.

And FIG. 6B shows a front view of an alternative example embodiment of the FOD heater of FIGS. 4A and 6A, wherein the heater sheets are shaped differently from the previous examples, but the first current flowing through the first heater sheet is essentially opposite the second current flowing through the second heater sheet, effectively canceling each other magnetically to create the reduced magnetic field.

### DETAILED DESCRIPTION

This invention relates to thermal micro-actuators known herein as Flying height On Demand (FOD) heaters in sliders included in hard disk drives. Embodiments of the invention include a hard disk drive with a slider containing an FOD heater using two heater sheets configured to be driven by electric currents flowing in essentially opposite directions, causing the magnetic field induced by the FOD heater to be much smaller than prior art FOD heaters using just one sheet with a single current direction.

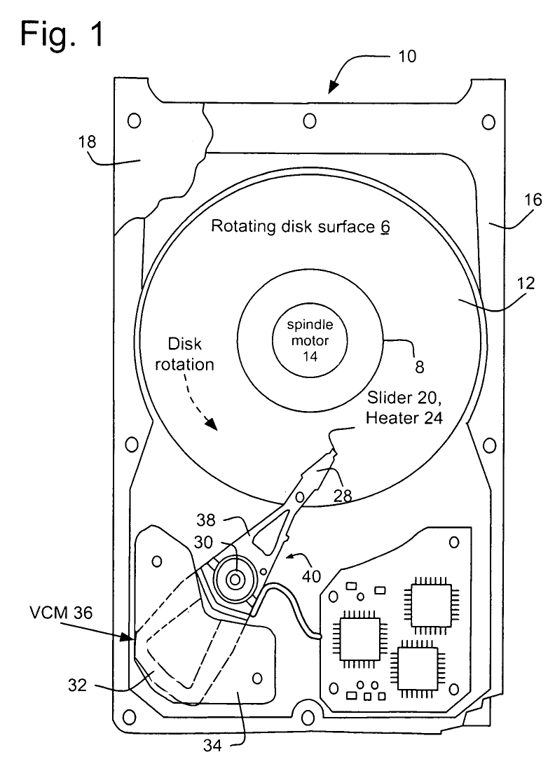

Referring to the drawings more particularly by reference numbers, FIG. 1 shows an example of an embodiment of the invention as a hard disk drive 10 including a disk base 16 to which a spindle motor 14 is mounted with at least one disk 12 rotatably coupled to the spindle motor to create a rotating disk surface 6. A voice coil motor 36 includes a head stack assembly 40 pivotably mounted by its actuator pivot 30 to the disk base, responsive to its voice coil 32 interacting with a fixed magnetic assembly 34 mounted on the disk base and includes at least one actuator arm 38 configured to move at least one head gimbal assembly 28 to position the invention's slider 20 with its Flying height On Demand (FOD) heater 24 near a track 8 on the rotating disk surface. A disk cover 18 is mounted upon the disk base to encapsulate all of the shown components except a control circuit, which is usually mounted on the opposite side of the disk base.

The hard disk drive 10 preferably accesses data arranged in tracks 8 on the rotating disk surface 6 by stimulating the spindle motor 14 to rotate the disks 12 at a preferred rate. The voice coil motor 26 operates by stimulating the voice coil 32 with a time varying electrical signal to magnetically interact with the fixed magnet assembly 34 causing the head stack assembly 40 to pivot about the actuator pivot 30 moving the actuator arm 38 and the head gimbal assembly 28 to position the slider 20 near the track on the rotating disk surface. The FOD heater 24 may be stimulated by an electrical current to heat up part of the slider, causing that portion of the slider to expand and reducing the distance of the read head and write head from the rotating disk surface, known herein as the flying height.

Embodiments of the invention further include but are not limited to the apparatus of the slider 20, the head gimbal assembly 28, and the head stack assembly 40, where both assemblies include at least one instance of the slider. Embodiments of the invention also include but are not limited to methods operating the hard disk drive and the slider.

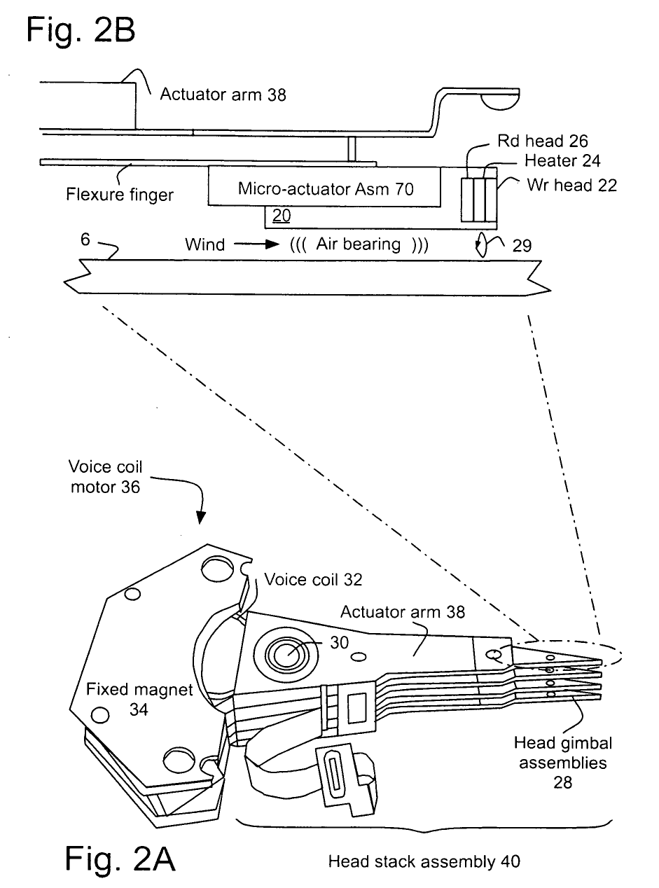

FIG. 2A shows a perspective view of some details an example of the voice coil motor 36 of FIG. 1 including the head stack assembly 40 with the voice coil 32, the actuator pivot 30, the actuator arm 38, and more than one head gimbal assembly for a hard disk drive including more than one disk.

FIG. 2B shows a side view of an example of the head gimbal assembly 28 of the previous Figures with an embodiment of the invention's slider 20 including the FOD heater 24 between the write head 22 and the read head 26 inducing a reduced magnetic field 29 affecting the heads and the rotating disk surface 6. The head gimbal assembly is shown including the slider coupled to a flexure finger through which it couples to other components mechanically coupling the head gimbal assembly to the actuator arm 38. The slider is preferably coupled to a micro-actuator assembly 70 that mounts to the flexure finger and is preferably used to further alter the position of the slider over the rotating disk surface, thereby providing a second stage of actuation to the positioning of the slider, the first being provided by the voice coil motor 36 as shown in previous Figures.

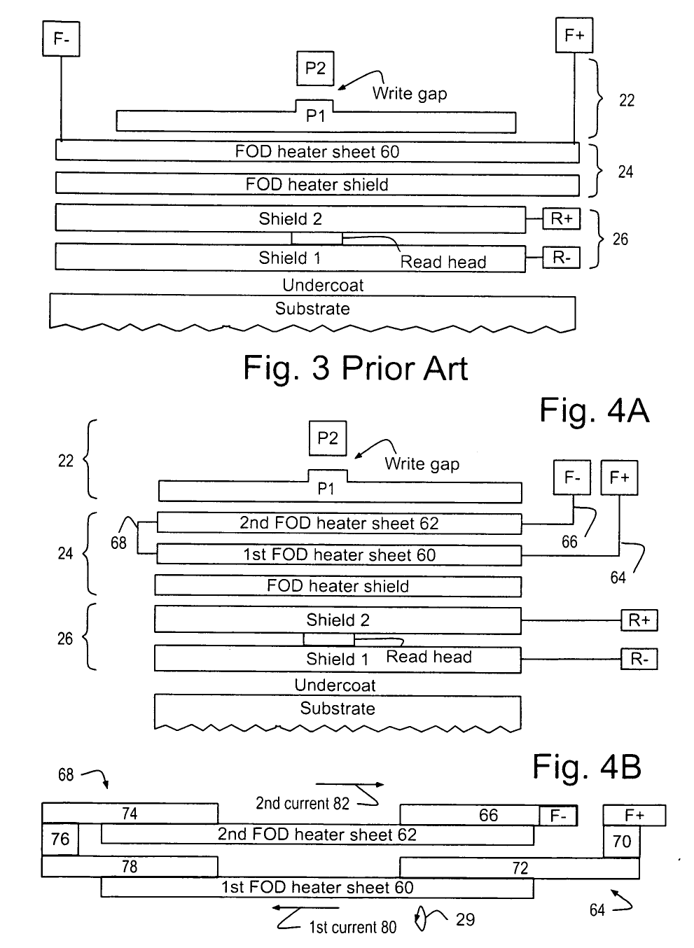

FIG. 3 shows an example prior art FOD heater 24 with a single heater sheet 60 as a layer diagram of the slider 20 as seen from the rotating disk surface 6 with the FOD heater situated between the write head 22 and the read head 26 with its F+ and F− contacts and single heater sheet. The current flowing in one direction between the contact, inducing the prior art magnetic field that is much stronger than the reduced magnetic field 29 of the invention's FOD heater as shown in FIG. 2B.

FIG. 4A shows an example of an embodiment of invention's slider 20 with its FOD heater 24 situated between the write head 22 and the read head 26. The FOD heater includes two heater sheets 60 and 62 electrically coupled in series between the F+ and F− contacts as seen from the rotating disk surface 6. The F+contact electrically couples to a side of the first heater sheet 60 whose other side is electrically coupled 64 to a side of the second heater sheet 62 whose other side is electrically coupled 66 to the F− contact.

FIG. 4B shows the FOD heater 24 of FIG. 4A with a first current 80 flowing through the first heater sheet 60 essentially opposite to the second current 82 flowing through the second heater sheet 62, effectively canceling each other magnetically to create the reduced magnetic field 29. In greater detail than shown in FIG. 4A, the F+ contact electrically couples through a first via 70 and a first conductor 72 to one side of the first heater sheet 60 whose second side is electrically coupled 64 to one side of the second heater sheet 62 whose second side is electrically coupled 66 through the second conductor to the F− contact. The electrical coupling 68 may include a conductor 78 electrically connected to the second side of the first FOD sheet, a second via 76 electrically connecting the conductor 78 to a conductor 74 electrically connected to the first side of the second heater sheet.

In some embodiments, the heater sheets 60 and 62 may include a heating compound such as Nickel-Chromium (NiCr) and/or Nickel-Iron (NiFe) and/or Nickel-Copper (NiCu). The conductors such as 66, 72, 74 and/or 78 may include metals such as Copper (Cu), gold (Au), Ruthenium (Ru), and/or Tantalum (Ta). The heating portion of the FOD heater 24 are usually considered to be the parts of the heater sheets 60 and 62 that are not in contact with the conductors. The terminal portions of for each of the contacts F+ and F− are considered to be the electrical assemblies of conductors and vias forming an electrical coupling to the heater sheet. An overcoat, which has not been shown, may be deposited as a layer at the trailing edge of a slider 20 over the write head 22, and may contain Alumina or Al₂O₃, as may the undercoat. Also, while the substrate may vary, it may contain Alumina and Titanium carbide possibly as represented by the chemical formula Al₂O₃—TiC. The substrate may further be treated as an electrical ground.

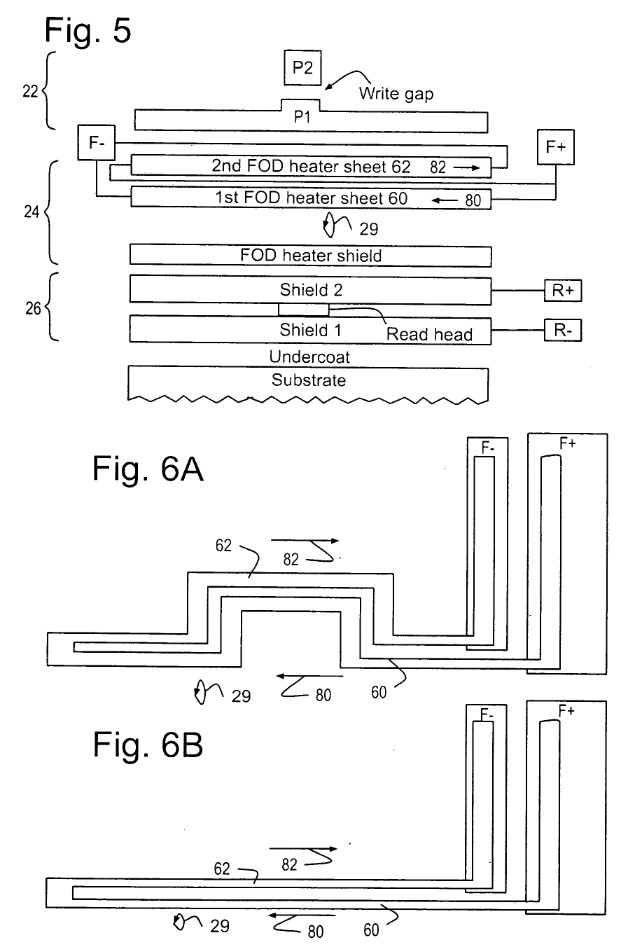

FIG. 5 shows an example of an embodiment of the invention's slider 20 with its FOD heater 24 including two heater sheets 60 and 62 electrically configured in parallel between the F+ and F− contacts, as seen from the rotating disk surface 6, with the parallel electrical couplings of these contacts to the first and second heater sheets configured for the first current flowing through the first heater sheet 60 essentially opposite of the second current flowing through the second heater sheet 62, effectively canceling each other magnetically to create the reduced magnetic field 29.

FIG. 6A shows a front view of one example embodiment of the FOD heater 24 of FIG. 4A, configured for the first current 80 to flow through the first heater sheet 60 to be essentially opposite the second current 82 flowing through the second heater sheet 62, effectively canceling each other magnetically to create the reduced magnetic field 29. The bump or dent in the sheets increases the resistance in a region of the slider 20, which will tend to focus the heat generated by the FOD heater. These two heater sheets may be formed from a single layer of heater material through an etching process and do not involve the use of vias 70 and 76 as shown in the example of FIG. 4B.

Simulation analysis of the prior art FOD heater versus the invention's FOD heater 24 showed a factor of fifteen reduction in magnetic field strength of the prior art example of FIG. 3 compared to the reduced magnetic field 29 of the example embodiment of FIG. 6A, and in some embodiments such as shown in FIGS. 4A and 4B, almost a factor of one thousand reduction was calculated. This reduction positively affects the read head 26, and write head 22 of the slider 20, and their interactions with data stored on the rotating disk surface 6 they access, improving performance and increasing the reliability and longevity of the hard disk drive 10.

Various embodiments of the slider 20 and its FOD heater 24 may employ many variations in the shapes of the heater sheets 60 and 62. The previous Figures have shown these sheets with bends in them. FIG. 6B shows a front view of an alternative example embodiment of the FOD heater of FIG. 6A, where the heater sheets are shaped differently, each forming an essentially straight electrical path, but the first current 80 flowing through the first heater sheet 60 is essentially opposite the second current 82 flowing through the second heater sheet 80, effectively canceling each other magnetically to create the reduced magnetic field 29. Both of the examples of FIGS. 6A and 6B can be formed by etching a single layer of heater material without requiring the vias shown in FIG. 4B.

The slider 20 may include the read head 26 employing a giant magneto-resistive effect to read a track 8 on the rotating disk surface. Alternatively, the read head may employ a tunneling magneto-resistive effect. The write head 22 may be a perpendicular recording write head or a longitudinal recording write head.

Embodiments of the invention include methods of making the slider, head gimbal assembly, head stack assembly and/or the hard disk drive. The slider 20 may be formed by deposition and/or etching and/or reactive processes creating the two heater sheets 60 and 62 and coupling them to the F+ and F− contacts to create the FOD heater 24 included in the slider. The head gimbal assembly 28 may be assembled from the slider coupled to a flexure finger, possibly through a micro-actuator assembly 70 as shown in FIG. 2B. The micro-actuator assembly may employ at least one of the following effects: a thermal mechanical effect, a piezo-electric effect and/or an electrostatic effect to alter the position of the slider over a rotating disk surface 6. The head stack assembly 40 may be made by coupling the head gimbal assembly to an actuator arm 38 to at east partly create the head stack assembly. The hard disk drive may be assembled as discussed for FIG. 1.

The preceding embodiments provide examples of the invention, and are not meant to constrain the scope of the following claims.

What is claimed is:

1. A hard disk drive comprising:
a disk base;
a spindle motor mounted on said disk base, said spindle motor rotatably coupled to a least one disk to create at least one rotating disk surface; and
a voice coil motor including
a head stack assembly pivotably mounted to said disk base by an actuator pivot to move a head gimbal assembly including a slider across said rotating disk surface,
said slider including a Flying height On Demand (FOD) heater including a first heater sheet and a second heater sheet, collectively configured for a first current across said first heater sheet generally opposite a second current across said second heater sheet to magnetically cancel each other to create a reduced magnetic field induced by said FOD heater.

2. The hard disk drive of claim 1, further comprising a read head, wherein to read a track on said rotating disk surface said read head employs a member selected from the group consisting of a giant magneto-resistive effect and a tunneling magneto-resistive effect.

3. The hard disk drive of claim 1, further comprising a write head, wherein said write head is selected from of the group consisting of a perpendicular recording write head and a longitudinal recording write head.

4. The hard disk drive of claim 1, wherein said FOD heater further includes a F+ contact and a F− contact.

5. The hard disk drive of claim 4, wherein said F+contact electrically couples to said first heater sheet in series through said second heater sheet to said F− contact.

6. The hard disk drive of claim 4, wherein said F+ contact electrically couples to said first heater sheet in parallel with said second heater sheet to said F− contact.

7. A slider for a hard disk drive comprising:
a FOD heater including a first heater sheet and a second heater sheet, collectively configured for a first current across said first heater sheet generally opposite a second current across said second heater sheet to magnetically cancel each other to create a reduced magnetic field induced by said FOD heater.

8. The slider of claim 7, further comprising a read head, wherein to read a track on said rotating disk surface said read head employs a member selected from the group consisting of a giant magneto-resistive effect and a tunneling magneto-resistive effect.

9. The slider of claim 7, further comprising a write head, wherein said write head is selected from the group consisting of a perpendicular recording write head and a longitudinal recording write head.

10. The slider of claim 7, wherein said FOD heater further includes a F+ contact and a F− contact.

11. The slider of claim 10, wherein said F+contact electrically couples to said first heater sheet in series through said second heater sheet to said F− contact.

12. The slider of claim 10, wherein said F+ contact electrically couples to said first heater sheet in parallel with said second heater sheet to said F− contact.

13. A method of operating an FOD heater in a slider, comprising the steps of:
applying a first current across a first heater sheet; and
applying a second current across a second sheet generally opposite said first current to magnetically cancel each other to create a reduced magnet field induced by said FOD heater.

14. A head stack assembly for a hard disk drive comprising:
a slider including an FOD heater including a first heater sheet and a second heater sheet, collectively configured for a first current across said first heater sheet essentially opposite a second current across said second heater sheet to magnetically cancel each other to create a reduced magnetic field induced by said FOD heater.

15. The head stack assembly of claim 14, wherein said FOD heater further includes a F+ contact and a F− contact.

16. The head stack assembly of claim 15, wherein said F+ contact electrically couples to said first heater sheet in series through said second heater sheet to said F− contact.

17. The head stack assembly of claim 15, wherein said F+ contact electrically couples to said first heater sheet in parallel with said second heater sheet to said F− contact.

18. A head gimbal assembly for a hard disk drive comprising:
a slider including a Flying height On Demand (FOD) heater including a first heater sheet and a second heater sheet, collectively configured for a first current across said first heater sheet essentially opposite a second current across said second heater sheet to magnetically cancel each other to create a reduced magnetic field induced by said FOD heater.

19. The head gimbal assembly of claim 18, wherein said FOD heater further includes a F+ contact and a F− contact, and wherein said F+ contact electrically couples to said first heater sheet in series through said second heater sheet to said F− contact.

20. The head gimbal assembly of claim 18, wherein said FOD heater further includes a F+ contact and a F− contact, and wherein said F+ contact electrically couples to said first heater sheet in parallel with said second heater sheet to said F− contact.
